(19) United States
(12) Patent Application Publication
(10) Pub. No.: US 2008/0023640 A1
(43) Pub. Date: Jan. 31, 2008

(54) Penetration Ionization Chamber

(75) Inventors: Shui-Hua Su, Taoyuan County (TW); Ming-Chen Yuan, Taoyuan County (TW); Chun-Liang Chen, Taoyuan County (TW)

Correspondence Address: WPAT, PC, 7225 BEVERLY ST., ANNANDALE, VA, 22003, US

(73) Assignee: INSTITUTE OF NUCLEAR ENERGY RESEARCH ATOMIC ENERGY ,EXECUTIVE YUAN, Taoyuan County (TW)

(21) Appl. No.: 11/530,140

(22) Filed: Sep. 8, 2006

(30) Foreign Application Priority Data
Jul. 28, 2006 (TW) 095127635

(51) Int. Cl. G01T 1/185; H01J 47/02

(52) U.S. Cl. 250/385.1

(57) ABSTRACT

A penetration ionization chamber includes a chamber, two outer electrode plates and a center electrode plate. The center electrode plate is disposed at the center of the chamber, and signals produced in the chamber can be collected completely by the center electrode plate to avoid signal losses and improve the accuracy of the test result of the ionization chamber. The center electrode plate also can maintain a constant internal volume of the chamber and prevent a change of effective volume within the chamber due to a change of electric field and enhance the stability of the test result of the ionization chamber. A protection electrode is wrapped by an insulation pin of the electrode and the outer insulation ring to form an insulation shield that can greatly reduce current leakage of the protection electrode and improve the accuracy of the test result of the ionization chamber.

### FIELD OF THE INVENTION

The present invention relates to an ionization chamber, and more particularly to a penetration ionization chamber capable of collecting all signals produced in a chamber to avoid any signal loss in the chamber and provide a more accurate measurement.

### BACKGROUND OF THE INVENTION

An ionization chamber is usually applied for testing and measuring an output of an irradiation device such as an X-ray machine, a cobalt 60 teletherapy apparatus, a linear accelerator and various radioactive measuring instruments to determine whether or not the irradiation device achieves the expected stability. To maximize the current output of an ionization chamber and minimize the space for a change of reaction, the penetration ionization chamber is generally installed at the geometric center of the front of the irradiation device. Meanwhile, all possible factors causing interferences to the output of the device should be lowered to improve the accuracy of the current measurement. To meet the aforementioned requirements, a good penetration ionization chamber should have the following characteristics:

1. The wall of the ionization chamber should be as thin as possible to reduce the possibility of output-blocking and spectrum changes. Further, the ionization chamber should come with consistent beam emission ranges and thickness to prevent excessively large changes to the output homogeneity. Referring to FIGS. 7 and 8 respectively for a schematic view of the structure of a traditional penetration ionization chamber and a cross-sectional view of a second electrode plate of the traditional penetration ionization chamber, the ionization chamber 3 is a cylindrical chamber 31 disposed parallel to a first electrode plate 32 and a second electrode plate 33 and serving as an anode and a cathode, wherein the two electrode plates are made of a plastic material. A side of the first electrode plate 32 that faces towards the chamber 31 is coated with graphite to define a first electric conducting portion (not shown in the figure), and a side of the second electrode plate 33 that faces towards the chamber 31 is also coated with graphite to define a second electric conducting portion 331, and an inner electrode 3312 and a protection electrode 3313 are formed respectively on the inner and outer side of an insulation ring 3311 on the second electric conducting portion 331and separated by the insulation ring 3311. However, the drawback of such arrangement resides on that the area of the inner electrode 3312 becomes smaller due to the installation of the insulation ring 3311 and the protection electrode 3313. The signal collected in the chamber 31 through the signal pin 311 is limited to a part of the ionization signals in an effective electric field between the inner electrode 3312 and the first electrode plate 32, but another part of the ionization signals produced at the protection electrode 3313 cannot not be collected, and thus such signals become unused signals that will cause a large error between the actual signals collected by the chamber 31 and the intensity of the emission and will result in an inaccurate measurement.

2. The protection electrode 3313 has an effect of protecting an electric field vertically, but the signals cannot be collected stably when an applied voltage source is changed to drive the signals within an effective range of the electric field in the chamber 31 to change accordingly.

3. Since the electric fields applied to the protection electrode 3313 and the inner electrode 3312 have the same electric potential, therefore the installation of the protection electrode 3313 can prevent a current leakage, but its blemish is that the second electrode plate 33 only has an inner electrode 3312 situated at its upper layer, and its bottom 332 or its lateral side 333 is made of a plastic material without any graphite coating. Therefore, there is still a chance for the occurrence of current leakages that will affect the accuracy of collecting signals.

In summation of the description above, finding a way of overcoming the shortcomings of the traditional ionization chambers becomes an important subject for the people skilled in the art, and a penetration ionization chamber that can overcome the shortcomings of the prior art is needed.

### SUMMARY OF THE INVENTION

The primary objective of the invention is to overcome the shortcomings of the prior art by providing a penetration ionization chamber that can completely and effectively connect ionization signals in a chamber by a center electrode plate to avoid a signal loss and improve the accuracy of the test result of the ionization chamber.

The secondary objective of the present invention is to provide a penetration ionization chamber that installs a center electrode plate for maintaining a constant volume in the chamber and preventing a change of electric field that may cause a change to the effective volume in the chamber, so as to improve the stability of the test result of the ionization chamber.

Another objective of the present invention is to provide a penetration ionization chamber that has a complete effective protection electrode for isolating any current leakage occurred between the center electrode plate and the outer electrodes and avoiding the possibility of having a current leakage.

To achieve the foregoing objectives, the present invention provides a penetration ionization chamber comprising: a chamber, two outer electrode plates and a center electrode plate. The chamber is a hollow body made of an electric conducting metal and has a plurality of support pins and a signal pin protruded from the internal wall of the chamber. The two outer electrode plates are fixed onto upper and lower sides of the chamber respectively, and a side of the two outer electrode plates that faces the chamber includes a first electric conducting portion. The center electrode plate is fixed in the chamber and has a second electric conducting portion for collecting the ionization signals in the chamber.

To make it easy for our examiner to understand the present invention, the following drawing and numerals will be used for a detail description of the present invention.

### BRIEF DESCRIPTION OF THE DRAWING

FIG. 1 is an exploded view of a preferred embodiment of the present invention;

FIG. 2 is a perspective view of FIG. 1;

FIG. 3 is a cross-sectional view of FIG. 2;

FIG. 4 is a bottom view of an internal structure of a support pin;

FIG. 5 is a bottom view of an internal structure of a signal pin;

FIG. 6 is a schematic view of an application of a preferred embodiment of the present invention;

FIG. 7 is a schematic view of a structure of a traditional penetration ionization chamber; and

FIG. 8 is a cross-sectional view of a second electrode plate as depicted in FIG. 7.

### DESCRIPTION OF THE PREFERRED EMBODIMENT

The structure and its connecting relation of the present invention will now be described in more detail hereinafter with reference to the accompanying drawings that show various embodiments of the invention as follows.

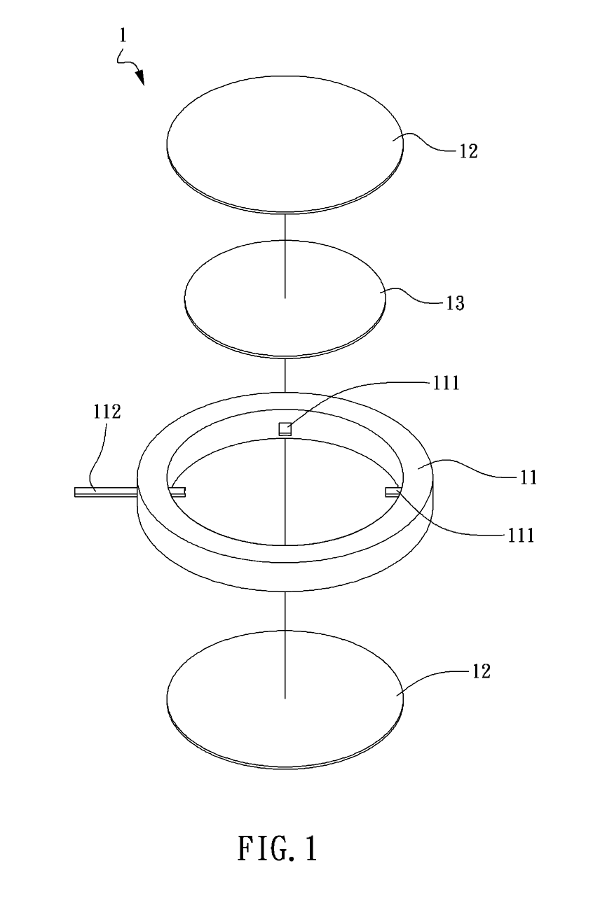

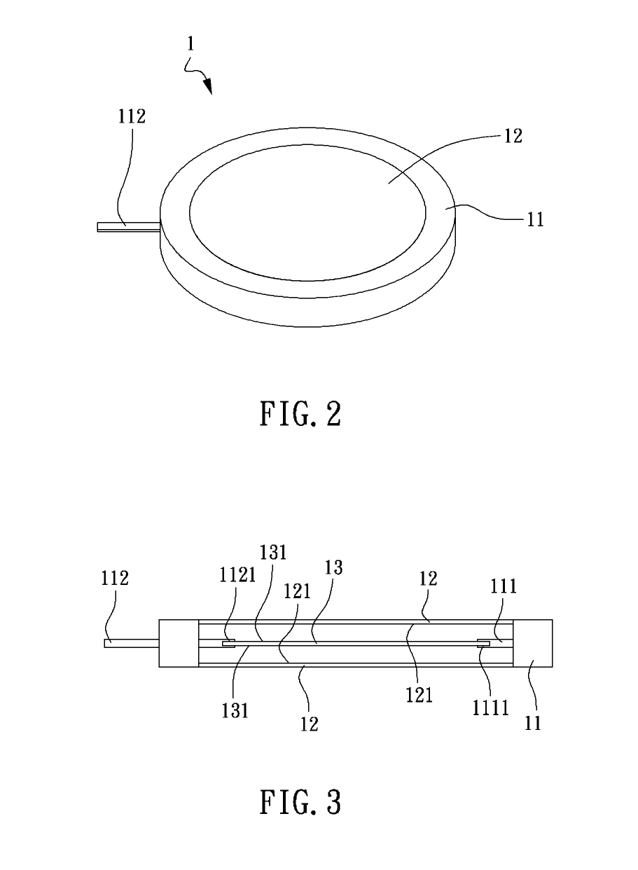

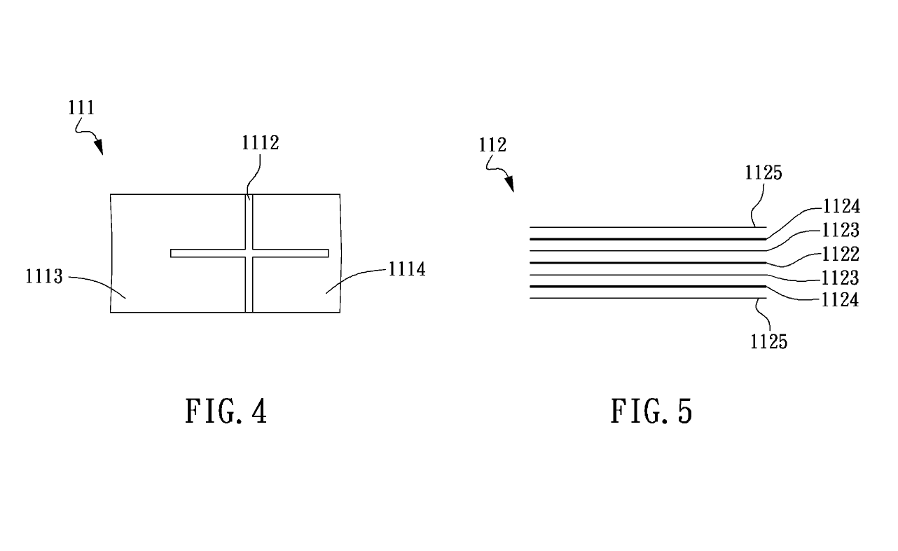

Referring to FIGS. 1 to 5 respectively for an exploded view of a preferred embodiment, a perspective view of a preferred embodiment, a cross-sectional view of a preferred embodiment, a bottom view of the internal structure of a support pin, and a bottom view of the internal structure of a signal pin in accordance with the present invention, a penetration ionization chamber 1 of the invention comprises a chamber 11, two outer electrode plates 12 and a center electrode plate 13.

The chamber 11 is a cylindrical hollow body made of an electric conducting metal which could be aluminum, copper, iron or one of their combinations. The chamber 11 has a plurality of support pins 111 and a signal pin 112 protruded from the internal wall of the chamber 11. The two outer electrode plates 12 are fixed respectively onto the upper and lower sides of the chamber 11 and made of a plastic material such as a polystyrene film. A side of the chamber 1 is coated with graphite to define a first electric conducting portion 121. The center electrode plate 13 is fixed in the chamber 11 for collecting ionization signals in the chamber 11 and made of a plastic material, and the whole surface of the center electrode plate 13 is coated with graphite to define a conductor of a second electric conducting portion 131.

The support pin 111 and the signal pin 112 separately have an end fixed to the chamber, and another end have a slot 1111, 1121 for holding the center electrode plate 13, wherein the support pin 111 comprises a protection electrode 1112, an electrode insulation pin 1113 and an outer insulation ring 1114, and the protection electrode 1112 is made of a metal such as aluminum, copper, iron, or their combinations and both ends of the protection electrode 1112 are wrapped by the electrode insulation pin 1113 and the outer insulation ring 1114 to define an insulation shield for greatly reducing the current leakage of the protection electrode 1112. Further, the signal pin 112 has a signal line 1122 electrically coupled to the center electrode plate 13 for outputting ionization signals in the chamber 11, and the external edge of the signal line is wrapped sequentially by an inner insulation ring 1123, a protection electrode ring 1124 and an outer insulation ring 1125, and these three layers of insulators can lower the possibility of a current leakage.

Further, the center electrode plate 13 is clamped by the slots 1111, 1121 of the support pin 111 and the signal pin 112 and fixed into the chamber 11 and disposed equidistantly from the two outer electrode plates 12. In other words, the center electrode plate 13 is installed at an interval of the same height and parallelly between the two outer electrode plates 12. The two outer electrode plates 12 are fixed respectively onto both upper and lower sides of the chamber 11 by screws, and the thickness of the two outer electrode plates is determined by the measured intensity of radiation, and factors such as blocking the output beams, changing the spectrum or losing the electron equilibrium should be taken into consideration. These factors are prior arts, and thus will not be described here.

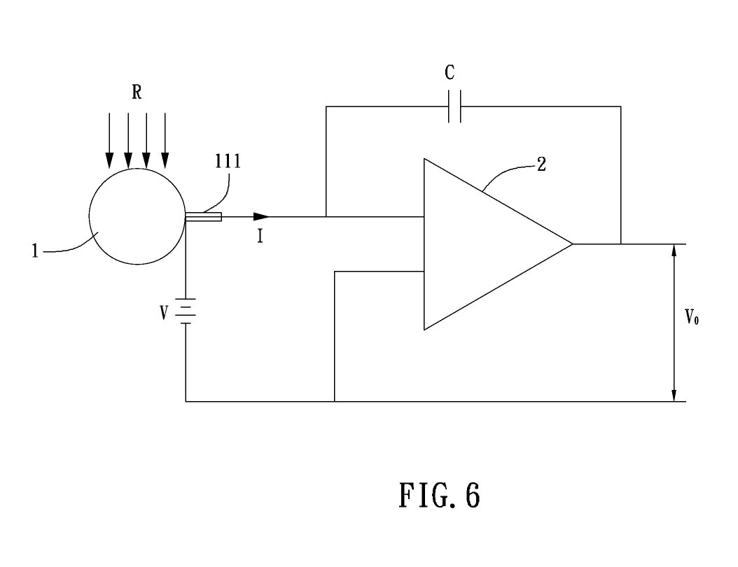

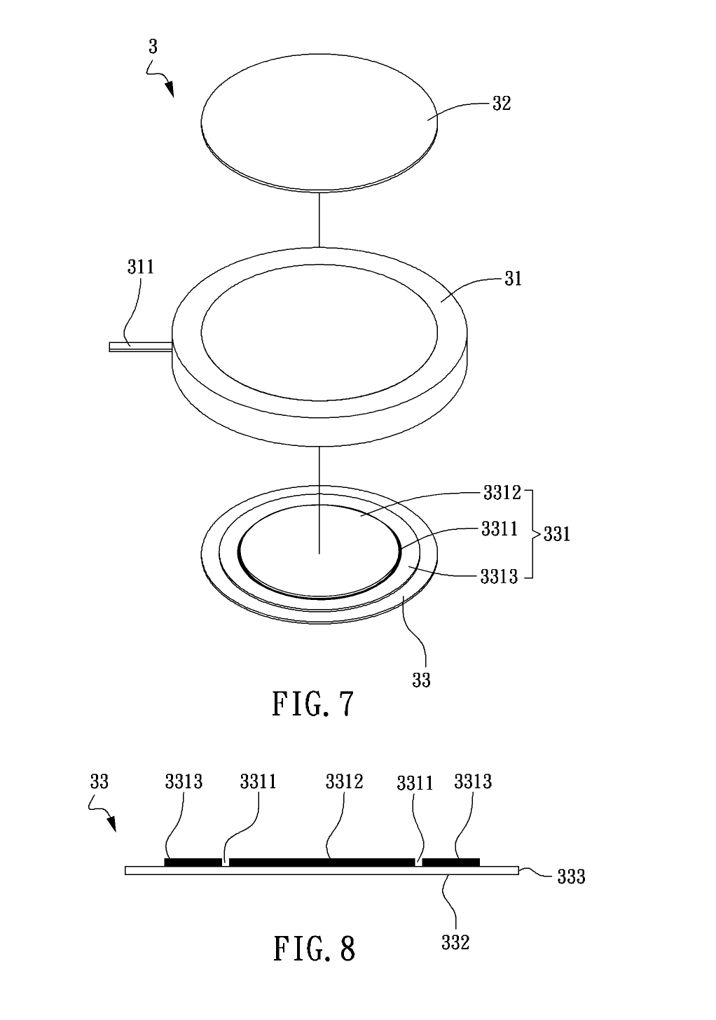

Referring to FIG. 6 for a schematic view of an application of a preferred embodiment of the present invention, the penetration ionization chamber should be installed before its use. Firstly, the signal pin 112 of the penetration ionization chamber 1 is connected to an electrometer 2 for supplying a high DC voltage source (V), and both of the center electrode plate and the protection electrode of the ionization chamber 1 are connected to the high DC voltage source (V) at the same time to maintain the same electric potential. Ion beams are projected from an ion beam device (not shown in the figure) to the ionization chamber 1, and the ionization radiation (R) emitted from the ion beams will ionize the air in the chamber, and the high DC voltage source (V) will separate anions and cations in the chamber to produce an ionization current (I) and pass the ionization current (I) to an input terminal of the electrometer 2 and a charge capacitor (C), and an output terminal of the electrometer 2 will receive a voltage output (Vo) for determining the intensity of the ionization radiation (R) emitted by the irradiation device.

In summation of the description above, the center electrode plate is installed in the chamber, and thus the ionization signals produced in the chamber can be collected completely by the center electrode plate. The invention not only avoids a signal loss, but also improves the accuracy of the test result of the ionization chamber. On the other hand, the center electrode plate can maintain a constant volume in the chamber and improve the stability of the test result of the ionization chamber by avoiding a change of the electric field and a change of the effective volume in the chamber. Further, the protection electrode is wrapped by the electrode insulation pin and the outer insulation ring, so that an excellent insulation shield is formed between both ends of the protection electrode and the center electrode plate to greatly reduce the possibility of a current leakage of the protection electrode. Such arrangement also can improve the accuracy of the test result of the ionization chamber.

In summation of the above description, the present invention herein enhances the performance than the conventional structure and further complies with the patent application requirements. While the invention has been described by means of specific embodiments, numerous modifications and variations could be made thereto by those skilled in the art without departing from the scope and spirit of the invention set forth in the claims.

What is claimed is:

1. A penetration ionization chamber, comprising:
a chamber, being a hollow body made of an electric conducting metal, and having a plurality of support pins and a signal pin protruded from an internal wall of said chamber;
two outer electrode plates, fixed to upper and lower sides of said chamber respectively, and each having a first electric conducting portion disposed on a side of said two outer electrode plates and facing said chamber; and
a center electrode plate, fixed in said chamber, and having a second electric conducting portion, for collecting an ionization signal in said chamber.

2. The penetration ionization chamber of claim 1, wherein said electric conducting metal is one selected from the collection of aluminum, copper, iron, and their combination.

3. The penetration ionization chamber of claim 1, wherein said two outer electrode plates are made of plastic.

4. The penetration ionization chamber of claim 1, wherein said first electric conducting portion is made of graphite.

5. The penetration ionization chamber of claim 1, wherein said center electrode plate is made of plastic.

6. The penetration ionization chamber of claim 1, wherein said second electric conducting portion is made of graphite.

7. The penetration ionization chamber of claim 1, wherein said center electrode plate and said two outer electrode plates are disposed equidistantly with each other.

8. The penetration ionization chamber of claim 1, wherein said support pin further comprises a protection electrode pin and an insulator.

9. The penetration ionization chamber of claim 8, wherein said protection electrode pin is made of metal.

10. The penetration ionization chamber of claim 9, wherein said metal is one selected from the collection of aluminum, copper, iron and their combination.
